(19) United States
(12) Patent Application Publication
(10) Pub. No.: US 2012/0062687 A1
(43) Pub. Date: Mar. 15, 2012

(54) SYSTEMS AND METHODS FOR SCHEDULING SHARED PROGRAM CONTENT VIDEOCONFERENCING

(75) Inventors: Krishna Sai, Cedar Park, TX (US); Edward Brakus, Austin, TX (US); Alain Nimri, Austin, TX (US); Jonathan Gallmeier, Austin, TX (US)

(73) Assignee: POLYCOM, INC., Pleasanton, CA (US)

(21) Appl. No.: 12/880,910

(22) Filed: Sep. 13, 2010

(51) Int. Cl. H04N 7/14

(52) U.S. Cl. 348/14.03; 348/14.08; 348/E07.077

(57) ABSTRACT

A videoconferencing system provides sharing program content during a videoconferencing session. A graphical user interface (GUI) allows participants to select a program to be shared and participants to share the selected program with. A scheduler communicates with the videoconferencing systems of the participants to tune or configure them to receive the selected shared program content at a scheduled time. The scheduler also communicates with a multipoint control unit (MCU) for initiating a videoconferencing session between the participants. The videoconferencing system combines mixed video streams received from the MCU with the program stream of the selected shared program and displays the combined stream on the display device. The scheduler can be located at a program service provider or at the initiating participant's videoconferencing system.

### FIELD OF THE INVENTION

The present invention relates generally to videoconferencing systems, and more particularly scheduling of shared video experience.

### BACKGROUND

Videoconferencing systems are increasingly being used to conduct meetings when participants are present at different locations. Typically, videoconferencing is carried out by having video conferencing equipment at each end where the videoconferencing equipment is capable of capturing both video and audio of people participating in the videoconference. Communication is established by receiving video and audio from the far end and transmitting video and audio captured from the near end to the far end. The received video of the far end participants is typically displayed on display screens placed in front of the near end participants. Traditionally, videoconferencing has been mostly implemented and used in corporate environments. However, reducing equipment costs, improving high bandwidth infrastructure availability to homes, videoconferencing is finding wide acceptance in home environments.

Certain home videoconferencing applications allow participants to share or watch the same entertainment program while carrying out a videoconferencing session. For example, FIG. 1 shows one of the participants 101 in a videoconferencing session with at least two other participants shown in windows 103 and 105 on the display screen 107. In addition to participating in a video conferencing session, participants 101, 103 and 105 also share the same programming content, shown in window 109, also displayed on display screen 107. The display screens (not shown) of remote participants 103 and 105 also display the same programming content 109 currently visible on the display screen 107 of participant 101.

Programming content 109 can be received from a program content provider, such as a cable television operator, via a receiver device. Each participant also requires videoconferencing equipment for establishing a videoconferencing session. Additionally, the receiver device and videoconferencing equipment at each of the participants need to coordinate such that the delivery of programming content 109 and the establishment of the videoconferencing session take place in the proper sequence ant at the desired time. Coordinating with all the participants and their receiving and videoconferencing equipment can become cumbersome. The situation can be further exacerbated when the number of participants is large.

### SUMMARY

A videoconferencing system for establishing a videoconferencing session with shared program content is disclosed. Two or more participants can watch the same programming content while carrying out a videoconferencing session. The videoconferencing system can include a set-top-box or receiver for receiving programming content from a service provider, a videoconferencing unit for establishing a videoconferencing call and a display screen for displaying shared program content and videoconferencing streams.

The set-top-box (STB) can include a radio frequency receiver for receiving programming content from television service providers such as cable television (CATV) and satellite television. STB can also include a network interface for receiving programming content over the Internet, for example, from IPTV service providers. STB can receive programming content from service providers by tuning the RF receiver to the frequency associated with the desired programming content. In case of IPTV, the STB can request receiving a media stream of the desired program from the IPTV service provider over the Internet. STB can also receive program listing or program guide from the service provider or a third party.

The videoconferencing unit (VCU) can receive videoconferencing video and audio streams of remote participants from a multipoint control unit (MCU). VCU can also receive video stream of program content from the STB. VCU can combine these two video streams and display the combined stream on a display device, when the operating in a shared content videoconferencing session. When not in videoconferencing mode, the VCU passes the program stream received from the STB without modification to the display device.

A graphical user interface (GUI) can be in the form of an interactive program guide (IPG) having selectable program fields. A participant can select the program he/she wants to share with one or more remote participants. The IPG can also allow the participant to select the one or more remote participants from a list of participants. IPG can also indicate which ones of the remote participants are capable of sharing the selected program.

Information for populating the IPG can be obtained from a program server at the service provider. Selections made by the participant on the IPG can also be communicated back to the program server. The program server can update a scheduler with the time of the start of the selected program the participants want to share. At or before the begin time of the shared program, the scheduler can communicate the STBs of the participants to tune or configure the STBs to receive the shared program content. Scheduler can also communicate with the MCU to initiate a videoconferencing session between the participants. MCU can communicate with the VCUs of the participants to establish the videoconferencing session.

In one example, programming and scheduling of the shared program content videoconferencing session can be carried out from the system of the initiating participant instead of the service provider. A program interface for providing program listing to the IPG can be located in the VCU. The VCU can also include a scheduler for receiving information of the selected shared program and the selected remote participants from the program interface. The scheduler can communicate with STBs of remote participants to tune or configure the STBs to receive the selected shared program. The scheduler can also communicate with the MCU to initiate a videoconferencing session between the initiating VCU and the VCUs of the selected remote participants.

In one example, the selected shared program content can be stored in non-volatile memories at the participants before the scheduled videoconferencing session. At the scheduled time, the shared program content can be sourced from the non-volatile memory instead of from the service provider.

### BRIEF DESCRIPTION OF THE DRAWINGS

Exemplary embodiments of the present invention will be more readily understood from reading the following description and by reference to the accompanying drawings, in which:

FIG. 1 illustrates a videoconferencing session with shared program content.

FIG. 2A shows an exemplary system for a participant to carry out videoconferencing with shared program content.

FIG. 2B depicts an exemplary functional block diagram of a set-top-box of FIG. 2A.

FIG. 2C depicts an exemplary functional block diagram of a videoconferencing unit of FIG. 2A.

FIG. 2D shows an alternate embodiment of the system of FIG. 2A.

FIG. 3 illustrates an exemplary network for carrying out videoconferencing with shared program content.

FIGS. 4A-4D depict an exemplary graphical user interface for scheduling videoconferencing with shared program content.

FIG. 5 illustrates an example where the scheduling of videoconferencing with shared program content can be carried out from the videoconferencing unit.

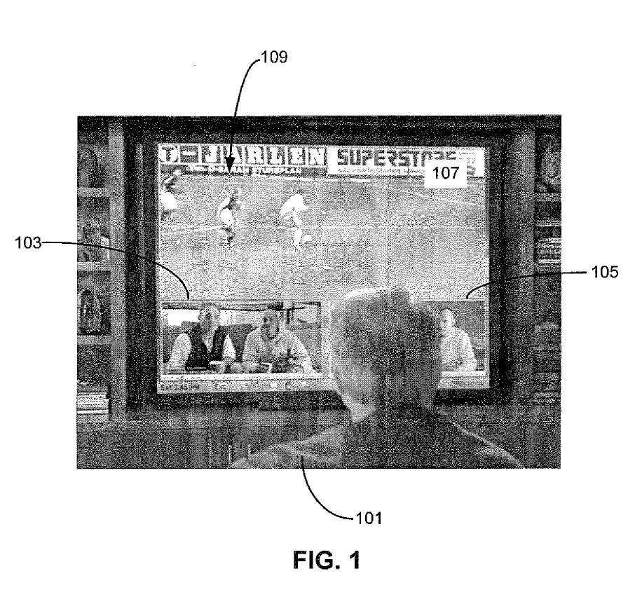

### DETAILED DESCRIPTION

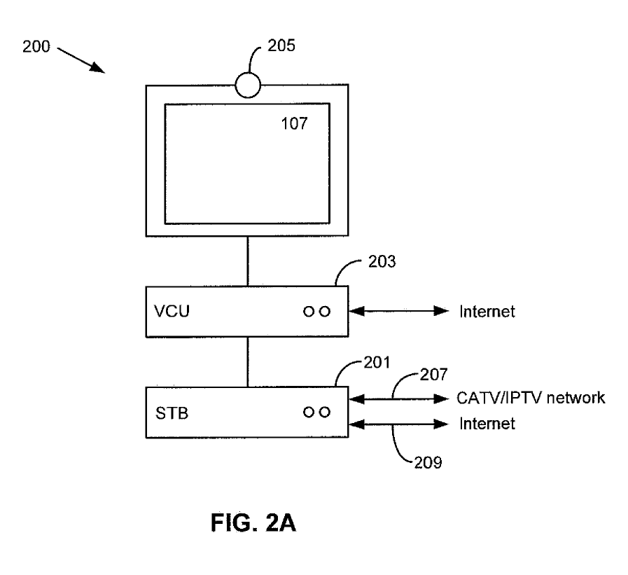

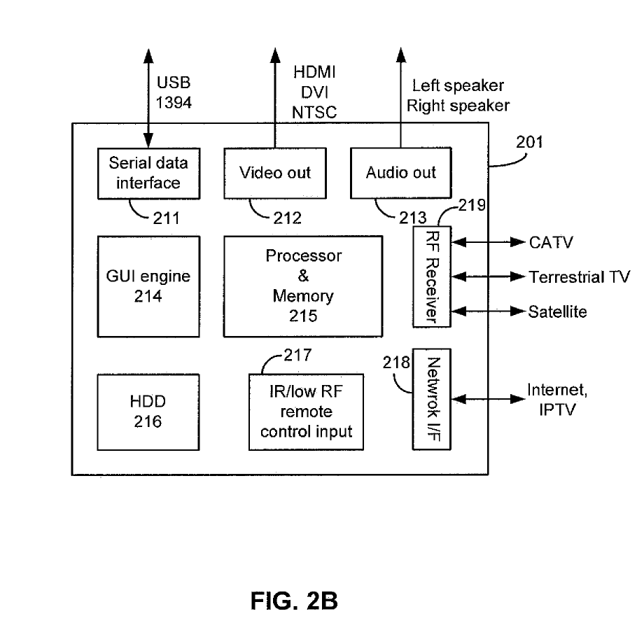

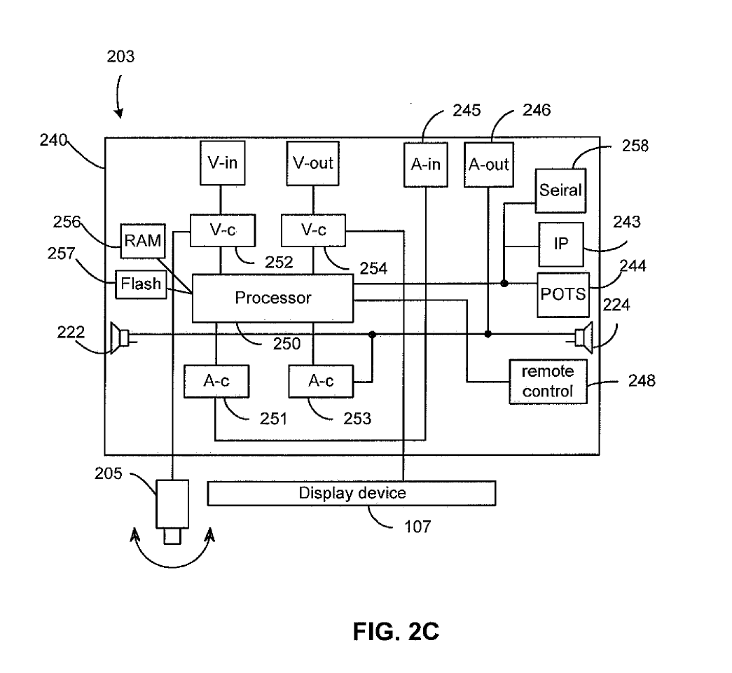

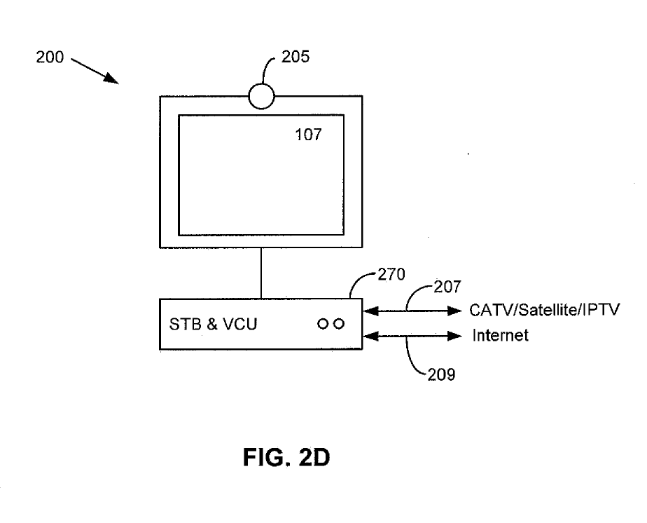

FIG. 2 shows an example of a system 200 that can be used to provide shared program content experience to participants during videoconferencing. System 200 can include a set-top-box (STB) 201, a videoconferencing unit (VCU) 203, a display device 107 and a camera 205. STB 201 can connect to a service provider, which provides content that the participants would like to share during a videoconferencing session. For example, the STB 201 can receive television programming from a cable television (CATV) operator, a satellite TV operator, terrestrial TV operators, Internet protocol TV (IPTV) operator, or any other entity that can provide audio visual content. The VCU 203 can establish a videoconferencing session with VCUs of remote participants. The VCU 203 can also combine the audio-visual data received as part of the videoconferencing session with audio-visual data received from the STB 201 as part of the shared content, and display the combined content on display device 107. The scheduling of the videoconferencing session among all the participants and receiving of shared content at all the participants can be carried out from the system 200.

FIG. 2A depicts an exemplary block diagram of STB 201. Various functional blocks of the STB 201 can be implemented in hardware, software, firmware or any combination of the preceding. STB 201 can include a RF receiver 219 for receiving modulated RF signals from via CATV, satellite TV, and terrestrial TV. A network interface 218 can be connected to the Internet, via which it can receive programming from an IPTV program operator. The network interface 219 can be a wireless or a wired interface.

Processor 215 can include analog-to-digital converters and codecs for processing the audio-visual programming received from RF receiver 219 and the network interface 218. Processor can also include protocol suites, such as TCP/IP and RTP/RTCP, etc., that can allow the STB 201 to communicate with program operators. Remote control receiver 217 can receive and decode signals from a remote control operated by the participant, and provide the decoded signals to the processor 215. For example, the processor 215 can receive a command from the user via the remote control to change channels. The processor 215 can then tune the RF receiver 219 to a frequency corresponding to the requested channel. Similarly, the processor 215 can send command packets to the IPTV operator requesting video steams that correspond to the requested channel.

A GUI engine 214 can generate a graphical user interface (GUI), which can be displayed to the participant on the display device 107. The GUI can be interactive, such that the participant can select fields and or buttons on a menu with the aid of the remote control, for example. The GUI can allow the participant to control the operation of STB 201. For example, the GUI can include an interactive programming guide (IPG), which includes a listing of current and future programming being received by the STB 201. Data for populating the IPG can be received from the program operators or from third parties. For example, the program guide data can be received from the CATV provider over an MPEG transport stream or from a third party over the Internet. As will be described in further detail below, the IPG can also allow the participant to select a program for sharing, and select the participants to share the selected program with.

Serial data interface 211 can include USB, IEEE 1394 (e.g., FireWire), etc. for sending and receiving control and other data. For example, the STB 201 can be connected to the VCU 203 via the serial interface USB for exchanging control data. Processor 215 can also process the received video and audio stream and convert them into a format appropriate for the display device 107. For example, processor 215 can convert incoming video stream into HDMI, DVI or NTSC format and output the video stream via video interface 212. Similarly, audio can be outputted to loudspeakers via audio interface 213. Video output from the STB 201 can be fed to a video input interface on the VCU 203. STB 201 can also include non-volatile memory 216, e.g., hard-disk drive (HDD), flash, etc., for general storage and for recording programs.

An exemplary block diagram of the VCU 203 is depicted in FIG. 2C. The VCU 203 can have a central module 240, which has internal loudspeakers 222 and 224, a connection to the installed camera 205 and a connection to the display device 107. The central module 240 can have many interfaces for additional video and audio components: video input interface 241, video output interface 242, audio input interface 245 and audio output interface 246. Each interface can have connections to multiple audio or video channels. For example, the video input interface 241 can accept video signals of shared content from the video output 212 of the STB 201. The video output interface 242 may output video streams to one or more display devices, e.g., display device 107. The audio input interface 245 may accept one or more microphones, which can be grouped into one or more audio channels. The audio output interface 246 may output one or more audio channels.

Signal processing and control can be performed by the processor unit 250, which can be coupled to various audio/video components or interfaces through intermediates 251, 252, 253 and 254. Those intermediates 251-254 can perform signal conversions, such as DAC, ADC etc. They are shown as separate blocks, but could be integrated into a single module or an integrated chip. The processor unit 250 can be supported by memory module 256 (typically RAM) and mass storage 257 (e.g., flash memory). Signal processing programs may be stored in the mass storage 257. The central module 240 can have several network interfaces, one interface 243 for a digital network, and another interface 244 for an analog network. Digital interface 243 may support various digital connections, such as ISDN, Ethernet, and other packet based networks. The ISDN connection is mainly used for a video conference connection through an ISDN network. The Ethernet or LAN connection is mainly used for video conference through the Internet or over a LAN. A serial interface connection 258 can be used to receive and transmit high speed data with other devices. For example, a USB connection may be used to exchange additional audio/video media stream, such as additional cameras, microphones, computers with additional documents etc. The USB connection may also be used to send control data to other devices, such as the STB 201. A remote control interface 248 is connected to the central module 240. The remote control interface 248 can receive control commands from a handheld remote control (not shown) and transmit the commands to the central module 240 to control the operation of the video conference unit 203.

Camera 205 can be a pan-tilt-zoom camera and can be controlled by processor 250. Although only one camera 205 is shown, additional cameras can be employed for wider coverage. Display device 107 can be a CRT, flat screen, LCD, O-LED, etc., type display device, and may display high definition content at 720p (1280×720), 1080p (1920×1080), or other resolution. More than one display devices can also be employed, such that the VCU 203 can output one video stream for each of the display devices. With multiple display devices, the VCU 203 may not need to combine the videoconferencing video stream with the shared program video stream, but instead display the two streams on two separate display devices. Of course, several configurations can be envisioned based on the number of videoconferencing streams, number of shared program streams, and the number of display devices.

Although FIG. 2A shows the STB 201 and the VCU 203 as separate devices, functionality of these devices can be combined into a single device 270 as shown, for example, in FIG. 2D. In such a system, a processor can carry out the functions of both processor 215 of STB 201 and processor 250 of VCU 203. Functional blocks common to both STB 201 and VCU 203, such as network interfaces, video and audio interfaces, etc. can be shared. Advantageously, the user may now need only a single remote controller, or other control device, to control both videoconferencing and programming functions.

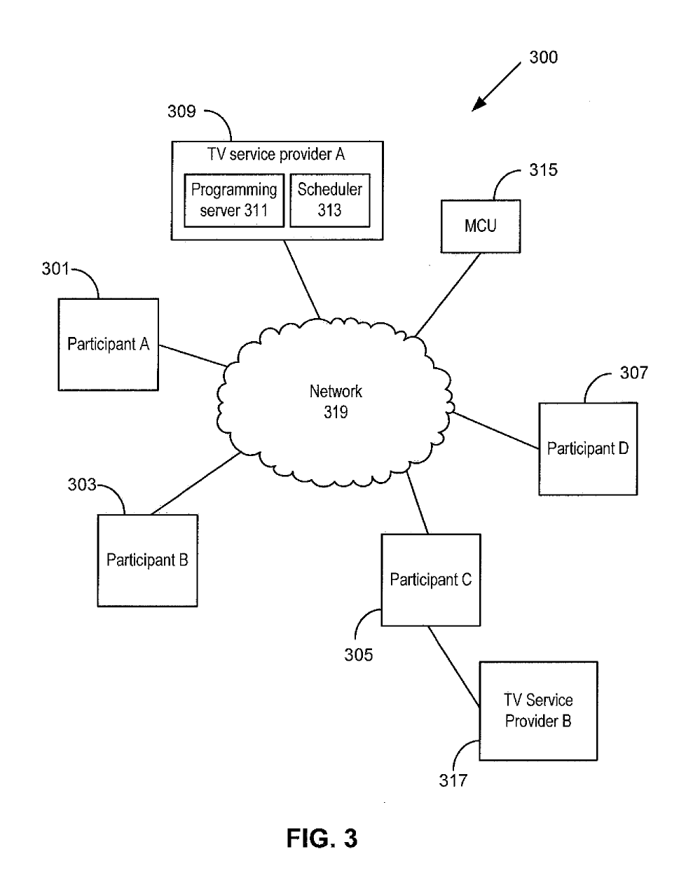

FIG. 3 shows an example of a system 300 for providing shared program content during a videoconference. Participant A 301, Participant B 303, Participant C 305, and Participant D 307 can each include the ability to participate in videoconferencing and to receive programming. For example, one or more of the participants in FIG. 3 can be similar to the exemplary system 200 depicted in FIGS. 2A-2D. Participants A-D 301, 303, 305, 307 can connect to one or more networks 319 for sending and receiving data. For example, networks 319 can include a CATV network, over which the participants' STBs 201 can receive programming content. Networks 319 can also include, for example, the Internet, over which the VCU 203 can send and receive videoconferencing data. TV service provider A 309 can provide programming content to the participants. However, all participants may not receive programming content from the same service provider. For example, participant C 305 can receive programming content from TV service provider B 317, such as direct broadcast satellite TV, which is different from service provider A 309, such as CATV. This can occur if participant C 305 is located in a different geographical location from other participants, or if participant C 305 has chosen a service provider B 317 that is different from service provider A 309.

Service provider A 309 can include a programming server 311 and a scheduler 313. Programming server 311 can provide programming information to the participants, which programming information can include continuously updated list of schedules of current and upcoming programming content. This list can be formatted by the STB 201 and presented as an interactive programming guide (IPG) to the participant on display device 107 using the STB's 201 graphical user interface. Scheduling information can be periodically sent to the STB 201, or can be sent to the STB 201 on the request of the participant (e.g., the participant pressing the “MENU” button on the remote control or the STB 201 front panel), or both. Programming information sent to the participants by the programming server 311 can include indication of which of the other participants receive the same programming content. Thus, when any one of the participants wishes to schedule shared programming content during a videoconferencing call, the participant can be aware of which of the other participants have the ability to receive the shared programming content.

Scheduler 313 can store scheduling data related to schedules selected by various participants. For example, scheduler 313 can receive such data from the programming server 311. Scheduling data can include participants' preferences for watching, recording, or sharing a particular program. When no videoconference call is involved, scheduler 313 can tune the STBs of the participants to display and/or record a particular programming content at the pre-selected time. When sharing during a videoconference call, the scheduler 313 in addition to tuning the STBs of the participants also communicates with the MCU 315 for setting up a videoconferencing call.

MCU 315 can be a separate entity as shown in FIG. 3, or can be part of the service provided by the service provider A 309. MCU 315 can initiate, establish and maintain a videoconferencing session between participants A-D 301-307. MCU 315 can initiate a videoconferencing session based on instructions from the scheduler 313 or any of the participants A-D 301-307. MCU 315 can receive audio and video data from VCUs of each of the participants. Received audio and video data can be mixed, and mixed audio and video data can be sent back to the participants. Service provider A 309 and participants A-D 301-307 can communicate with MCU 315 using H.323 protocols.

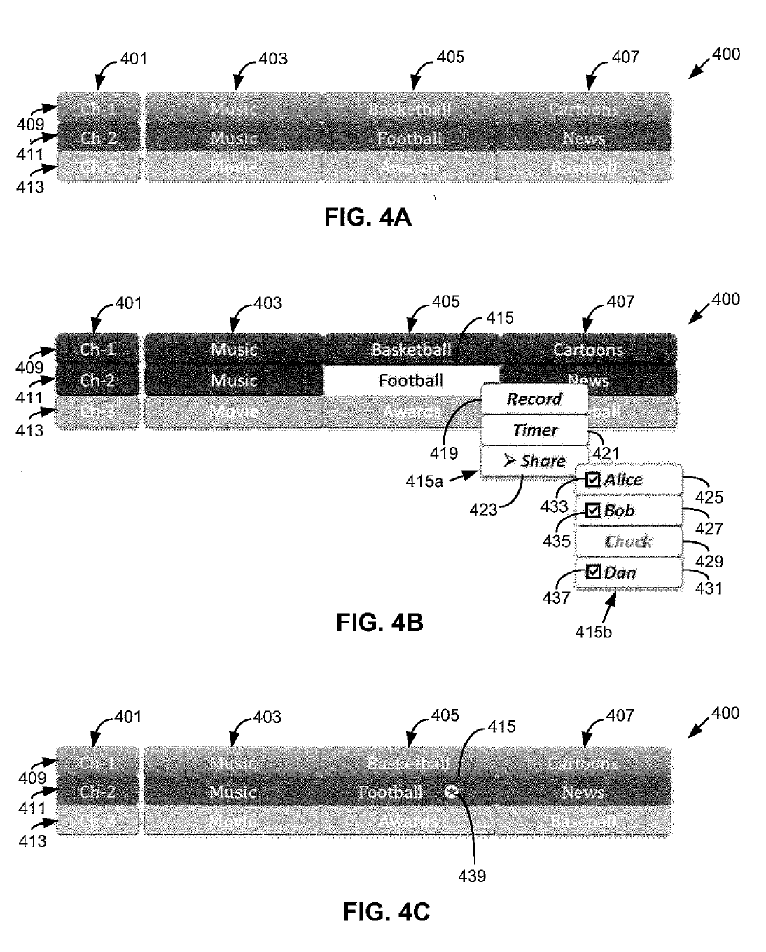

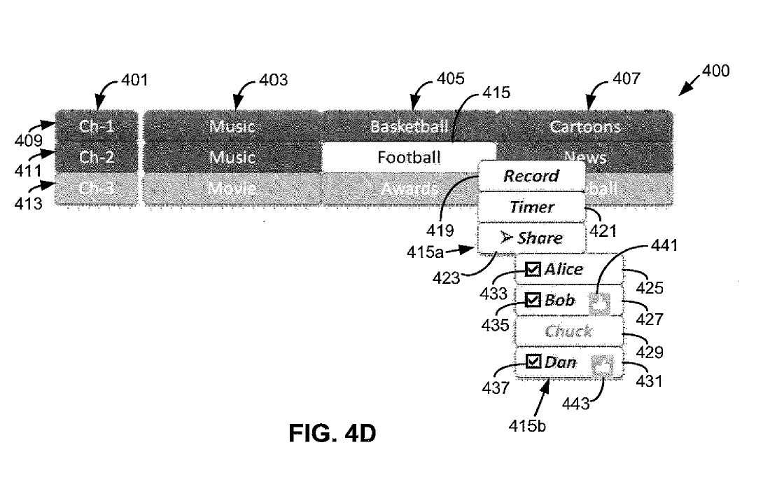

Discussion now turns to the interactive program guide provided by the STB to the participant for selecting shared programming content. FIG. 4A shows an exemplary graphical user interface 400 displayed to a participant, (e.g., “Eve”) by the STB 203 on display device 107. Various programming channels are arranged in rows 409, 411, and 413. Although only three channels (Ch-1, Ch-2, and Ch-3) have been shown, the program guide 400 can include additional channels. Furthermore, instead of labels such as Ch-1, Ch-2, etc., actual channel names, e.g., NBC, CBS, etc., may be displayed. For each channel, current and future programming can be displayed in the corresponding row. For example, row 409 can display a sequence of three programs “Music,” “Basketball,” and “Cartoons” within time slots 403, 405, and 407, respectively. Similarly, programming for Ch-2 and Ch-3 can be displayed as in rows 411 and 413. Time slots 403, 405, and 407 can indicate the duration of programming content. For example, each time slot 403, 405, and 407 may be of one hour duration. The beginning and end of each time slot may also have additional labels indicating the actual begin and end time of the programming content. For example the beginning of time slot 403 can have the label 2:00 pm, while the end of the time slot can have the label 3:00 pm.

One or more of the programs such as “Music,” “Basketball,” “Cartoons,” etc., can be selectable by the participant. The selection can be carried out by the participant by using up-down-right-left arrow buttons on a remote control, by a mouse pointer, touch screen, or any other user interface peripheral known in the art. Upon selection of a program, the IPG can display additional sub-menu options to the participant. For example in FIG. 4B, participant can select the program titled “Football” 415 for sharing with other participants during a videoconference. Upon selection of “Football” 415, a sub-menu 415a can be displayed to the participant. The sub-menu 415a can include additional selectable options. For example, the participant can select “Record” 419 to instantly begin recording the selected program, “Timer” 421 to record the program at a future time, or “Share” 423 to share the program with other participants. Selecting “Share” 423 can allow a participant the select the associated program for sharing during a videoconference. Typically, a traditional IPG will not include the “Share” 423 selection field. However, by integrating the scheduling of shared content by way of “Share” 423 into the traditional IPG view, the participant can be provided with the additional feature in an environment that the participant is already familiar with.

Upon the participant selecting “Share” 419, the IPG can provide another sub-menu 415b that lists the names of potential remote participants that the selected program can be shared with. For example, sub-menu 415b can list “Alice” 425, “Bob” 427, “Chuck” 429, and “Dan” 431. The list of other participant within the sub-menu 415b can be prepared a priori and stored with the programming server 311. Sub-menu 415b can also include selection boxes 433, 435, and 437 for allowing the participant to select and invite remote participants for sharing programming content. For example, the participant can select selection box 435 to select “Bob” 427 to be invited for sharing programming content. Sub-menu 415b may not present a selection box for participants who are not able to share content. For example, “Chuck” 429 does not have a selection box. “Chuck” 429 may be unable to share programming for number of reasons, for example, it does not receive the programming channel Ch-2, or receives programming content from another service provider, etc.

After the initiating participant selects the remote participants he/she wishes to invite to share programming content, STB 201 can send this information back to the programming server 311. Programming server 311 can store and maintain a list of all selected participants, and send invitations to each of the selected participants. For example, selected participants, Alice, Bob, and Dan can receive an invitation or notification that they have been invited to share a program. The invitation can include the name of the program, name/number of the channel, time and duration of the program (e.g., “Football” on Ch-2 at 2:00 pm for 1 hr), etc. Such invitation can be sent to the STBs of Alice, Bob, and Dan, which in turn can display the invitations on their respective display devices. For example, Bob can then use his remote control or other peripheral device communicating with the STB to accept or decline the invitation. Bob's STB can then transmit Bob's response back to the programming server 311.

Alternatively, the selection of shared programming content can be carried out out-of-band, i.e., sent to an entity other than the STB. For example, the interactive programming guide 400 can be displayed onto a participant's computer, smartphone, personal-digital-assistant (PDA), or any other such device. Invited participants can also receive notifications in the form of emails, text messages, etc. informing them that a shared videoconferencing call request awaits their response at their STB. Participants' responses can also be transmitted, e.g., over the Internet, to programming server 311, where the programming server 311 can take further action.

Programming server 311 can update the stored list of selected participants with their responses. Additionally, the programming server 311 can send updated information back to the initiating participant. For example, an indication that one or more of the invited participants have responded can be made by way of a “star” symbol 439 appearing next to the program 415 selected to be shared, as shown in FIG. 4C. The participant can then select the program 415 to access the sub-menu 415b as shown in FIG. 4D. Sub-menu 415b can display that invitees Bob and Dan have accepted the invitation to share program 415 by way of symbols 441 and 443. Sub-menu 415b can also indicate that invitees have not responded to their request by not displaying any symbol next to their names (e.g., Alice 425). If an invitee declines a request to participate, then the sub-menu 415b can display an appropriate symbol next to their name indicating that that invitee has declined to participate.

As mentioned previously, programming server 311 can also communicate with the scheduler 313 to notify the scheduler with information regarding shared programming content session initiated by each participant. For example, programming server can provide identification information of all participants that have agreed to participate in shared program content videoconferencing call. For example, referring to FIG. 4D, programming server 311 can send identification information of Bob, Dan, and Eve to the scheduler 313. Scheduler 313 may already have information corresponding to participants Bob, Dan, and Eve stored in a database. Such information can include the network address of the STBs of the participants. However, scheduler 313 can request this information from programming server 311. Programming server 311 can also communicate information regarding programming content that the participants have agreed to share. Such programming content information can include the name/title of the program, the channel the program is being broadcast on, the duration of the program, etc. Generally, any information that the scheduler 313 may require to tune/configure the STBs of each participant to receive the selected shared programming content may be provided by the programming server 311.

Just before, or at the time when the agreed upon shared program is to begin, the scheduler can communicate with the STBs of each of the participants to tune or configure the STBs to the selected shared program. For example, at or before 2:00 pm, when the selected shared program “Football” 415 is to begin, scheduler 313 can communicate with STBs of participants Bob, Dan, and Eve to tune or configure their STBs to the scheduled programming channel, e.g., Ch-2. Additionally, scheduler 313 can communicate with MCU 315 to initiate a videoconferencing call between participants Bob, Dan, and Eve.

MCU 315 can initiate a videoconferencing call with VCUs of each of the participants. For example, MCU 315 can communicate with VCUs of Bob, Dan, and Eve to initiate a videoconferencing call. Initiation and establishment of a videoconference call can be based upon well known protocols, such as H.323. Each VCU can send and receive compressed video and audio streams to the MCU 315. For example, VCUs of Bob, Dan, and Eve can compress and transmit video streams form their respective cameras (e.g., 205, FIG. 2) to MCU 315. MCU 315 can mix the received video and audio streams and transmit the mixed streams back to each VCU. Typically, a video and audio stream transmitted to a particular VCU can include mixed video and audio stream received from all other VCUs except from that particular VCU itself. For example, the VCU of Eve can receive mixed video and audio streams that include the video and audio received by the MCU 315 form Bob and Dan. Similarly, Bob can receive mixed video and audio of Dan and Eve, and so on.

MCU 315 can also communicate the mode of the ensuing videoconference to the VCU of each participant. For example, if the videoconference call being set up by MCU 315 does not involve sharing programming content, then the VCUs can display only the video streams received from the MCU 315. However, if the videoconferencing call involves sharing programming content, then such information can be communicated to each VCU. Consequently the VCUs can display not only the video streams received from the MCU 315 but also the video output of the STBs, which video output can include the selected shared programming content. For example, referring to FIG. 2, VCU 203 can combine the video streams received from the MCU via the Internet with the video stream of selected shared program received from the STB 201 and display the combined video on the display 107. With additional reference to the example shown in FIG. 4D, the VCU 203 can receive video steam or streams of Bob and Dan from the MCU, and the video stream of the selected shared program “Football” (415, FIG. 4C). VCU 201 can combine these received images to produce a combined video stream, which can be displayed to Eve on display screen 107.

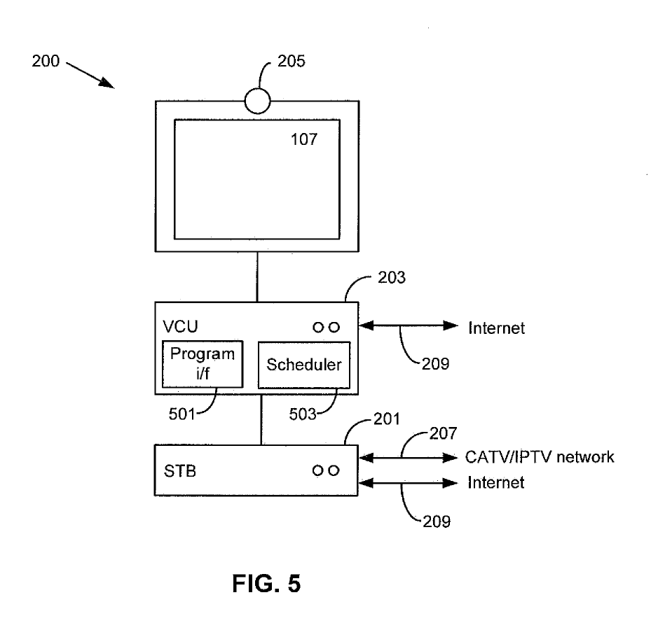

In an alternate example, the scheduling of shared programming can be carried out by the one or more VCUs instead of the scheduler 313. As an example, FIG. 5, VCU 203 includes a programming interface 501 and a scheduler 503. Programming interface 501 can display an interactive program guide (similar to the one shown in FIGS. 4A-4D) to the participant on the display screen 107. Alternatively, programming interface 501 can behave in a manner similar to the programming server 311. In this case, the GUI can be operated by the STB 201, but the STB 201 can send user selections to the programming interface 501 at the VCU 203 instead of the programming server 311 at the service provider 309. Programming data for populating the interactive program guide can be acquired over the Internet from the service provider A 309 or from a third party that provides programming data of service provider A 309. A participant wishing to initiate a shared programming content videoconferencing call can then make selections using a peripheral, such as a remote controller, mouse pointer, etc., that can communicate with the VCU 203. The selection of a program and the participants can proceed in a manner similar to the one shown in FIGS. 4A-4B.

The program selected for sharing can be communicated to the VCUs of the invitees selected by the initiating participant. For example, Eve's VCU 203 can communicate over the Internet with program interfaces of VCUs of selected invitees—Alice, Bob, and Dan—to send information regarding the selected program “Football” 415 and associated information. Program interfaces of VCUs of Alice, Bob, and Dan can present this information to Alice, Bob, and Dan on their respective display devices for their response. Response of Alice, Bob, and Dan can then be communicated back to the program interface 501 at VCU 203 of Eve. Once any response is received, program interface 501 of VCU 203 can update a response list stored in the VCU. Response updates can also be presented to the initiating participant on the IPG similar to the manner shown in FIGS. 4C-4D. Program interface 501 can update scheduler 503 with the title, channel, and time of the selected shared program. Scheduler 503 can use this information to setup a videoconferencing call and to tune the STB at the appropriate time.

At or just before the scheduled time the shared program is about to begin, the scheduler 503 can being initiating a videoconference call with the invitees that have agreed to join the shared program content videoconferencing call. To initiate a videoconferencing call, the scheduler 503 can communicate information regarding each invitee to the MCU 315, which information can include the network addresses of the VCUs of the participating invitees (e.g., Bob and Dan), and any other information required by the MCU 315 for initiating a videoconferencing call. MCU 315 can communicate with each VCU 203 to establish a videoconferencing call.

Tuning of STBs of participants can be carried out by their respective VCUs. Note that the program interface 501 at each participating VCU can update the scheduler 503 with the starting time and channel of the shared program. Therefore, at the scheduled time, the scheduler 503 of at each participant can communicate with their respective STBs to tune to the selected channel. The video stream outputted from the STB can be received by the VCU, which in turn can combine the program video stream with the video streams of the other participants received from the MCU 315 and display the combined video stream on the display device 107.

It is also envisioned that the participants can share previously recorded programming content instead of sharing programming content that is being currently broadcast or transmitted by the program operator. In one instance, the participant can select the time of shared videoconference in the “Timer” 421 field. If this time is after the time at which the program “Football” 415 is being broadcast, the scheduler 313 (or scheduler 503) can instruct the STBs of each participant to record the program and store it in HDD 216. When the time for videoconferencing arrives, the scheduler 313 can initiate a videoconferencing session, and instruct the STBs to source the program content to be shared from the HDD 216. Thus, participants can share programs during videoconferencing at whatever time that is convenient to them.

It is also envisioned that the participants can share programming content that is not received from the program operator. Such programming content can include personal recorded content. The programming menu can be extended to include HDD 216 directory listing, in place of channel names in column 401 (FIG. 4). Names of files that can be shared can appear in the row corresponding to the directory name. On selecting the file to be shared, a sub-menu (similar to 415a) can list the names of other participants that also have the same file stored in their HDDs. Initiating participant can also select the time at which the videoconferencing session is to begin. When the time for videoconferencing arrives, scheduler 313 (or scheduler 503) can initiate a videoconferencing session and instruct the STBs to source the program content to be shared from the selected directory and file in HDD 216.

The above description is illustrative and not restrictive. Many variations of the invention will become apparent to those skilled in the art upon review of this disclosure. The scope of the invention should therefore be determined not with reference to the above description, but instead with reference to the appended claims along with their full scope of equivalents.

What is claimed is:

1. A method for establishing a videoconferencing call with shared programming content by a program operator, the method comprising:
receiving information identifying the shared programming content from an initiating participant;
receiving identification information of one or more invited participants from the initiating participant;
configuring receivers associated with the initiating participant and the one or more invited participants to receive the shared programming content; and
communicating with a multipoint control unit to establish a video conferencing call between the initiating participant and the one or more invited participant.

2. The method of claim 1, wherein configuring receivers comprises configuring the receivers before a begin time of the shared programming content.

3. The method of claim 1, further comprising sending an invitation to each of the one or more invited participants after receiving identification information, wherein configuring receivers comprises configuring receivers associated with only those of the one or more invited participants that have accepted the invitation.

4. The method of claim 3, further comprising sending invitation response of the one or more invited participants to the initiating participant.

5. The method of claim 1, wherein the initiating participant and the one or more invited participants receive the shared programming content from the program operator.

6. The method of claim 1, wherein the initiating participant and the one or more invited participants receive the shared programming content from their respective non-volatile memories.

7. The method of claim 6, wherein the shared programming content includes personal recorded content of the initiating participant or the one or more invited participants.

8. The method of claim 5, wherein the program operator is an Internet Protocol Television provider.

9. A device communicably connected to a videoconference unit and communicably connected to a program operator, the device comprising:
a network interface configured to communicate with the program operator;
a video output interface configured to communicate with the videoconference unit; and
a processor communicably connected to the network interface and the video output interface, the processor configured to perform the steps of:
providing a graphical user interface (GUI) for scheduling a videoconferencing session with shared program content, the scheduling comprising selecting a shared program and selecting one or more remote participants,
communicating information on the selected shared program and the selected one or more remote participants to the program operator via the network interface,
receiving the selected shared program data from the program operator via the network interface, and
sending a video stream of the shared program to the videoconferencing unit via the video output interface.

10. The device of claim 9, further comprising a non-volatile storage communicably connected to the processor, wherein the processor is further configured to perform the steps of storing the received selected shared program data in the non-volatile storage, and wherein the video stream of the shared program is sourced from the selected shared program data stored in the non-volatile storage.

11. The device of claim 10, wherein the receiving occurs before a time scheduled for initiating the videoconferencing session.

12. The device of claim 9, wherein the processor is further configured to perform the steps of receiving invitation acceptance or denial information for one or more selected remote participants from the program operator, and wherein providing the GUI further comprises providing a visual indicator based on the acceptance or denial information.

13. A videoconferencing unit communicably connected to a program receiver, a multipoint control unit (MCU), and a display device, the videoconferencing unit comprising:
a network interface configured to communicate with the MCU;
a video output interface configured to communicate with the display device;
a video input interface configured to communicate with the program receiver;
a processor, communicably connected to the network interface, the video input interface, and the video output interface, the processor configured to perform the steps of:
receiving mixed video streams from the MCU via the network interface;
receiving shared program content from the program receiver via the video input interface,
if the video conference unit is in a shared program content videoconferencing mode, combining the mixed video stream and the shared program content to generate a combined stream and sending the combined stream to the display device via the video output interface.

14. The videoconferencing unit of claim 13, the processor further configured to perform the steps of:
receiving scheduling information from the program receiver, the scheduling information comprising information on a selected shared program and on selected one or more remote participant;
communicating with the selected one or more remote participants to send invitations and receive invitation responses.

15. The videoconferencing unit of claim 14, the processor further configured to perform the steps of:
configuring the program receiver to receive the shared program, and
communicating with the MCU via the network interface to initiate a videoconference with the selected one or more remote participant.

16. A method for providing a graphical user interface for scheduling a videoconferencing session with shared program content, comprising:
displaying an interactive program guide on a display device, the interactive program guide comprising selectable program title fields;
displaying a first sub-menu upon selection of a program title field, the first sub-menu including a selectable share field;
displaying a second sub-menu upon selection of the share field; the second sub-menu including a selectable list of invitees;
adding a first indicator to the selected program title field, the first indicator indicating that the program has been selected for sharing during a videoconferencing call.

17. The method of claim 16, further comprising adding a second indicator against one or more invitees that have accepted an invitation.

18. The method of claim 16, further comprising adding a third indicator against one or more invitees that have declined an invitation.
